(19) United States
(12) Patent Application Publication
(10) Pub. No.: US 2023/0137040 A1
(43) Pub. Date: May 4, 2023

(54) SYSTEM AND A METHOD FOR PROCESSING CONTAINERS AND HIGH VISCOSITY MATERIAL CONTAINED THEREIN

(71) Applicant: GROUPE SINOX INC., Saint-Anselme (CA)

(72) Inventors: Ahmed SAIGHI, Lévis (CA); Christophe BADAN, Orsay (FR); Antoine LONGCHAMP-AUBÉ, St-Anselme (CA); Rémi GAGNÉ, Lévis (CA)

(21) Appl. No.: 18/049,872

(22) Filed: Oct. 26, 2022

Related U.S. Application Data
(60) Provisional application No. 63/263,376, filed on Nov. 1, 2021.

(51) Int. Cl. B08B 9/08

(52) U.S. Cl. CPC B08B 9/0813; B08B 9/0826; B08B 2230/01; B08B 2209/08

(57) ABSTRACT

A method and a system for processing containers and viscous material contained therein, the method delivering the containers to a rinsing tunnel; transferring the containers exiting the rinsing tunnel to a cap removal station; transferring the containers with respective cap thereof removed, from the cap removal station to a pumping and washing station; transferring the containers from the pumping and washing station to an exit; whereby, in a continuous process, exterior surfaces of the containers are rinsed under pressurized water jets in the rinsing tunnel; the cap of each container is removed is the cap removal station to free a top opening therein; at the pumping and washing station, material is pumped from inside of the containers through the opening, pumped material being transferred to first tanks, and the inside of the containers is rinsed; produced rinsing waters being sent to second tank.

### CROSS REFERENCE TO RELATED APPLICATIONS

This application claims benefit of U.S. provisional application Ser. No. 63/263,376, filed on Nov. 1, 2021. All documents above are incorporated herein in their entirety by reference.

### FIELD OF THE INVENTION

The present invention relates to processing of high viscosity products. More specifically, the present invention is concerned with a system and a method for processing containers and high viscosity material contained therein, from revery of the material and reuse of the containers.

### BACKGROUND OF THE INVENTION

The maple syrup industry still uses rudimentary methods and systems for handling maple syrup from barrels delivered by producers to processing plants. At the processing plants, the syrup is pumped out of the delivered barrels to buffer receiving tanks and packaged or processed. The delivered barrels of maple syrup are typically stored at a temperature between 10 and 20 C°, before transfer to a washing area for rinsing by an operator, Once thus first emptied of their content, with residual syrup remaining on the sides and at the bottom thereof, the barrels are manually transferred to a drip station for recovery of this residual syrup, prior to being hand washed, dried and closed by hand. The washed barrels are returned to the producers.

The methods for managing the syrup barrels from and back to producers vary from processing plant to processing plant; amounts of syrup are wasted even though some of the wash water is boiled again for further sugars recovery in some cases. Overall, the current methods are energy intensive and require a lot of human resources.

There is still a need in the art for a system and a method for processing high viscosity products containers.

### SUMMARY OF THE INVENTION

More specifically, in accordance with the present invention, there is provided method for processing containers and viscous material contained therein, comprising delivering the containers to a rinsing tunnel; transferring the containers exiting the rinsing tunnel to a cap removal station; transferring the containers with respective cap thereof removed, from the cap removal station to a pumping and washing station; transferring the containers from the pumping and washing station to an exit; whereby, in a continuous process, exterior surfaces of the containers are rinsed under pressurized water jets in the rinsing tunnel; the cap of each container is removed is the cap removal station to free a top opening therein; at the pumping and washing station, material is pumped from inside of the containers through the opening, pumped material being transferred to first tanks, and the inside of the containers is rinsed; produced rinsing waters being sent to the second tank.

There is further provided a system for processing containers and viscous material contained therein, comprising a rinsing tunnel; a cap removal station; a pumping and washing station; receiving tanks; and conveyers; wherein, in a continuous process, a deposit conveyer receives input containers at a landing station and delivers the containers to the gravity conveyer leading to the rinsing tunnel for rinsing exterior surfaces of the barrels; a rinsing tunnel conveyer delivers the containers from the rinsing tunnel to the cap removal station for removal of caps from the containers; a pumping station conveyer conveys the containers from the cap removal station to the pumping and washing station; an exit conveyer delivering emptied containers from the pumping and washing station to a delivery exit; wherein the pumping and washing station comprises stations positioning the containers and a wand connected to a vacuum unit, the containers being positioned for insertion of the wand within the containers and pumping viscous material therefrom, pumped viscous material being transferred to first receiving tanks, and the wand being used to rinse the containers when emptied inside of the containers is rinsed and rinsing waters are delivered to second receiving tanks.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A is a top general view of a system according to an embodiment of an aspect of the present disclosure;

FIG. 1B is a second top general view of the system of FIG. 1A;

FIG. 2A is a schematical view of a system according to an embodiment of an aspect of the present disclosure;

FIG. 2B shows a deposit conveyer 20 in the system of FIG. 2A;

FIG. 2C shows a gravity feed conveyer in the system of FIG. 2A;

FIG. 2D shows a rinsing tunnel conveyer in the system of FIG. 2A;

FIG. 2E shows the inside of the rinsing tunnel FIG. 2D;

FIG. 2F shows a barrel cap removal station in the system of FIG. 2A;

FIG. 2G shows a pumping station conveyer from the barrel cap removal station to the pumping station of the system;

FIG. 2H shows a positioning and tilting station in the pumping station of the system;

FIG. 2I shows a gravity exit conveyer in the system of FIG. 2A;

FIG. 2J shows a catwalk in the system of FIG. 2A;

FIG. 2K shows a cap washer in the system of FIG. 2A;

FIG. 2L shows a maple syrup receiving tank receiver in the system of FIG. 2A;

FIG. 2M shows a sweet water receiving tank receiver in the system of FIG. 2A;

FIG. 2N shows a vacuum system for pumping both syrup and sweet water;

FIG. 2O shows the pumping and washing station;

FIG. 2P shows a safety enclosure in the pumping and washing station of FIG. 2O;

FIGS. 2Q shows the safety enclosure;

FIG. 2R shows a detail of the safety enclosure;

FIGS. 3A, 3B, 3C, 3D and 3E show details of conveyers in the system according to an embodiment of an aspect of the present disclosure;

FIG. 4A is a first schematic view of the rinsing tunnel 50 and the pumping station according to an embodiment of an aspect of the present disclosure;

FIG. 4B is a second schematic view of the rinsing tunnel 50 and the pumping station;

FIGS. 4C, 4B, 4C, 4D, 4E and 4F show a wand according to an embodiment of an aspect of the present disclosure;

FIGS. 4G, 4H, 4I and 4J show movement of the wand according to an embodiment of an aspect of the present disclosure;

FIGS. 4K, 4L and 4M show movement of the wand according to an embodiment of an aspect of the present disclosure;

FIGS. 4N, 4O, 4P and 4Q show controls of movement of the wand according to an embodiment of an aspect of the present disclosure;

FIG. 4R shows a safety enclosure for the pumping station according to an embodiment of an aspect of the present disclosure;

FIG. 5A shows an exploded view of rinsing, transfer and pumping conveyers a system according to an embodiment of an aspect of the present disclosure;

FIG. 5B shows a side view of the rinsing, transfer and pumping conveyers; and

FIG. 5C shows retaining pins for quick disassembly of a grating used to walk on according to an embodiment of an aspect of the present disclosure.

### DESCRIPTION OF ILLUSTRATIVE EMBODIMENTS

The present invention is illustrated in further details by the following non-limiting examples.

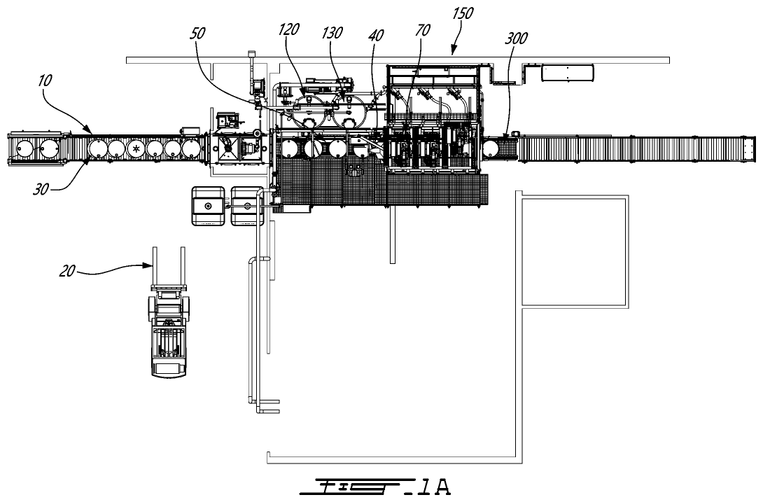

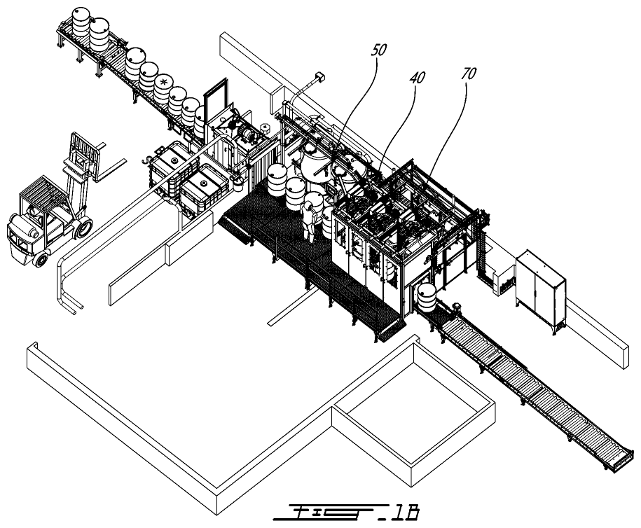

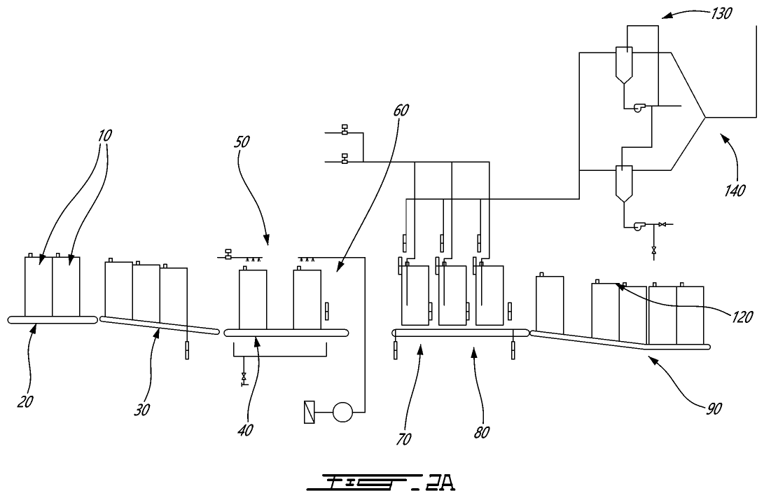

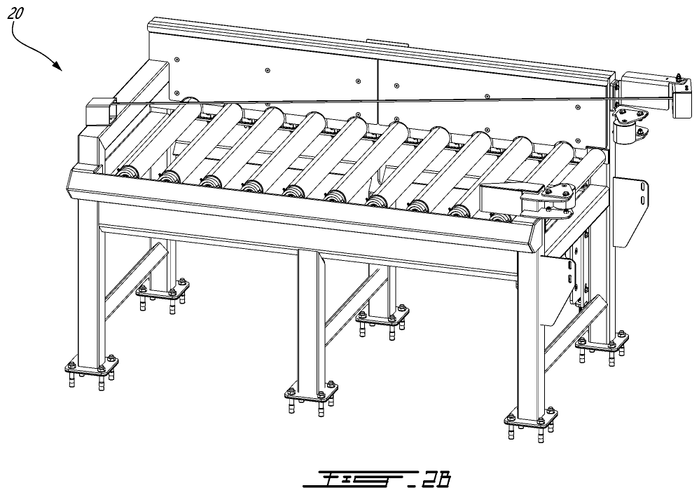

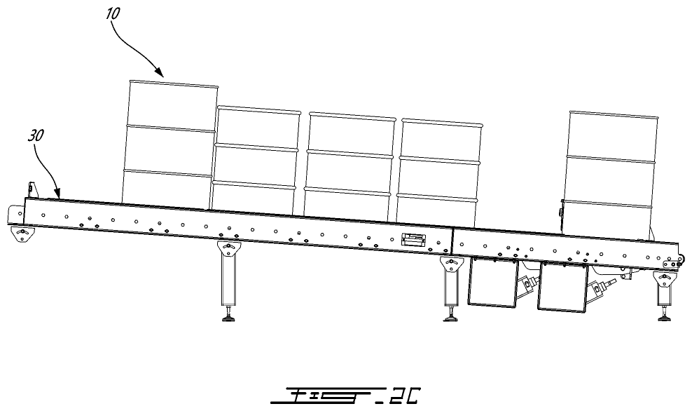

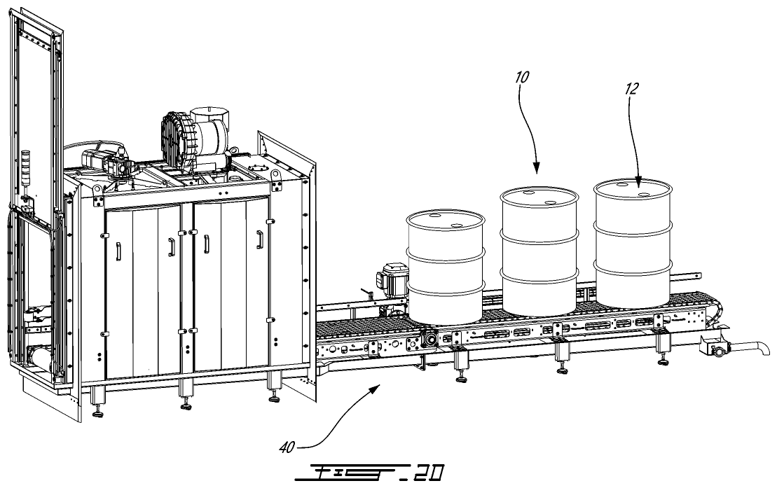

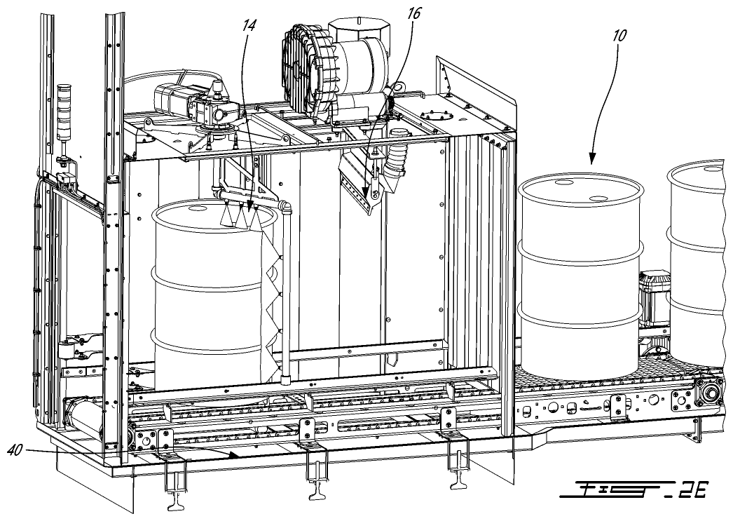

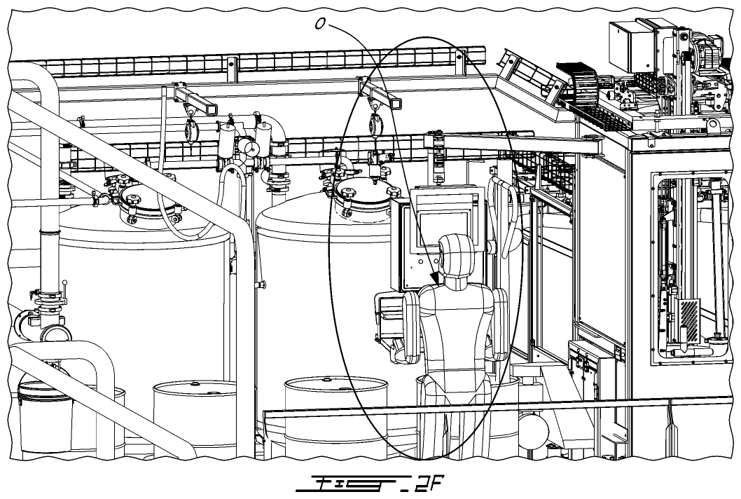

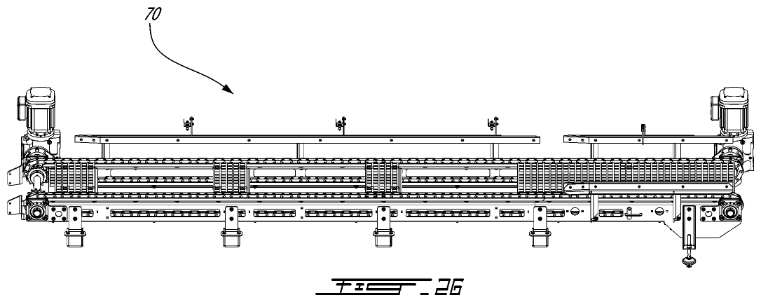

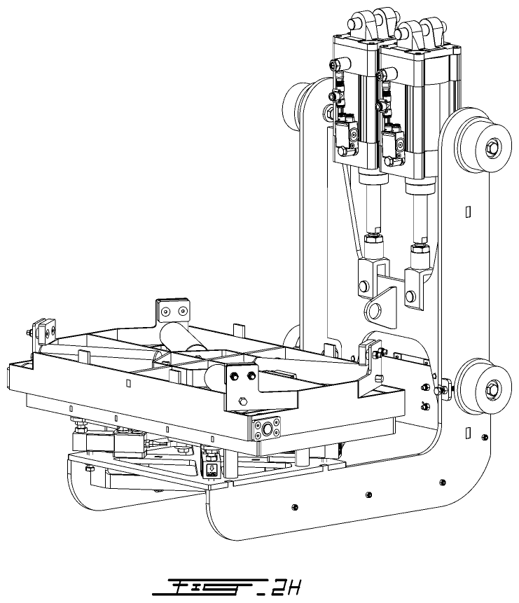

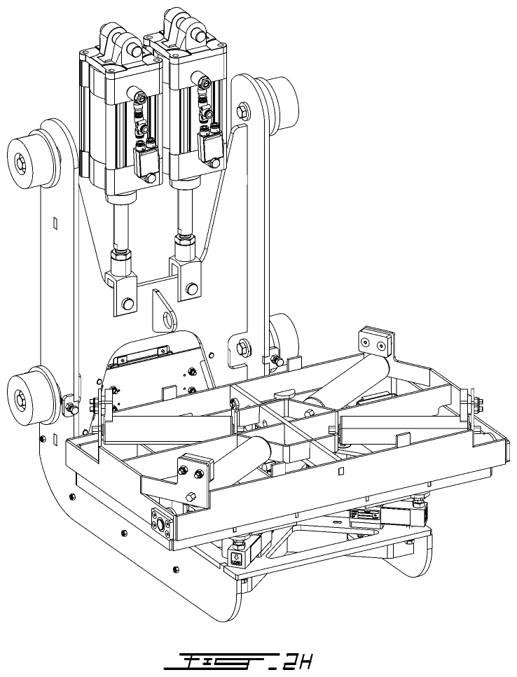

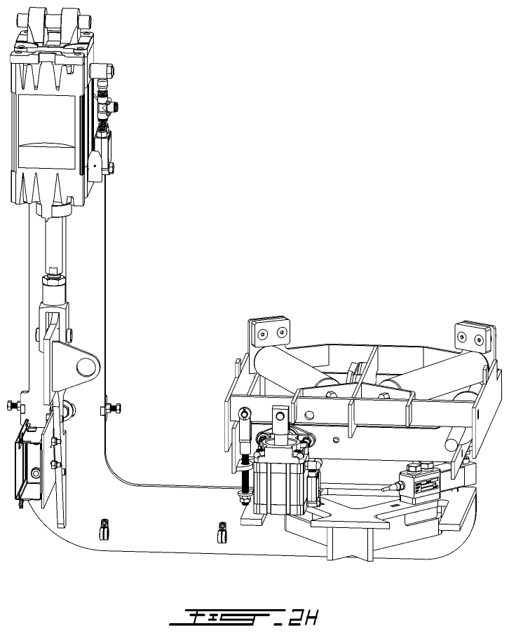

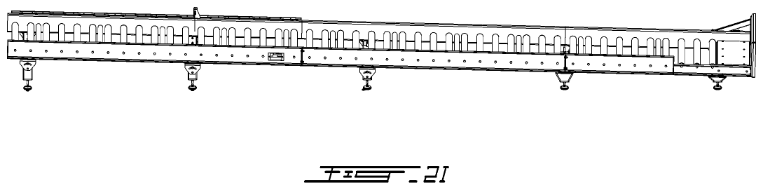

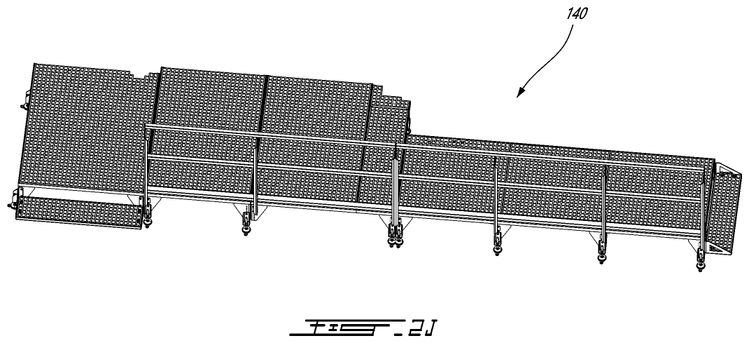

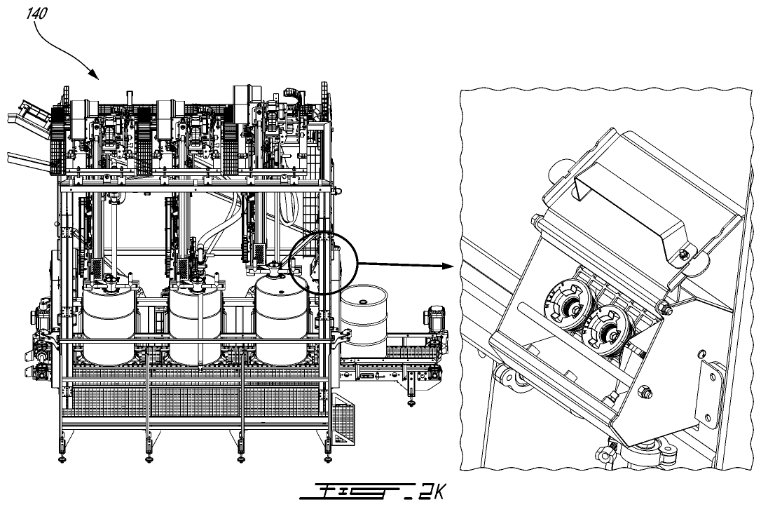

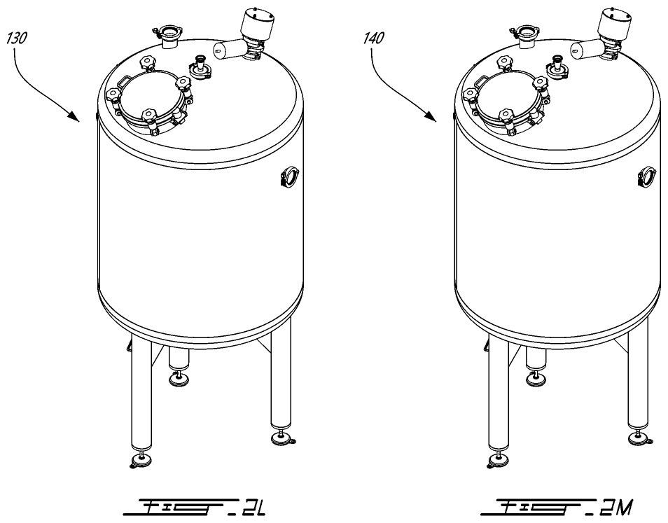

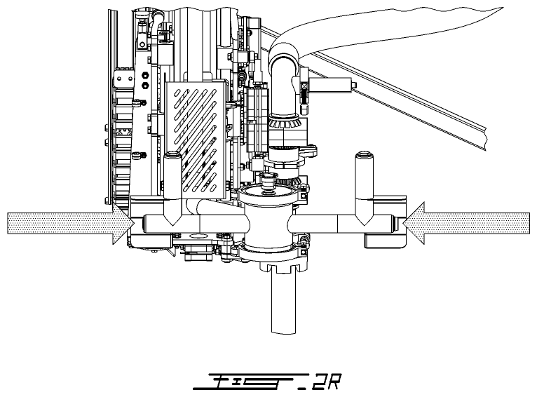

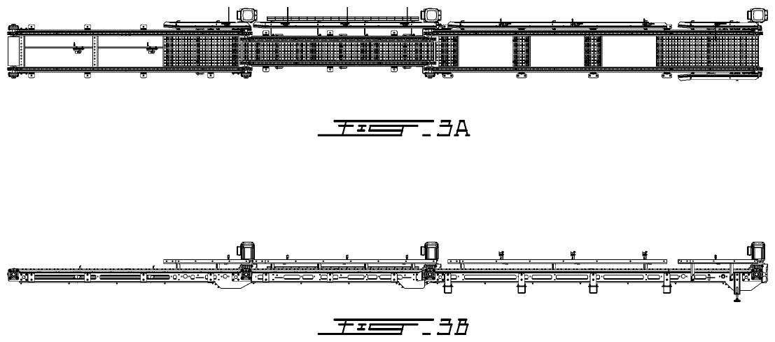

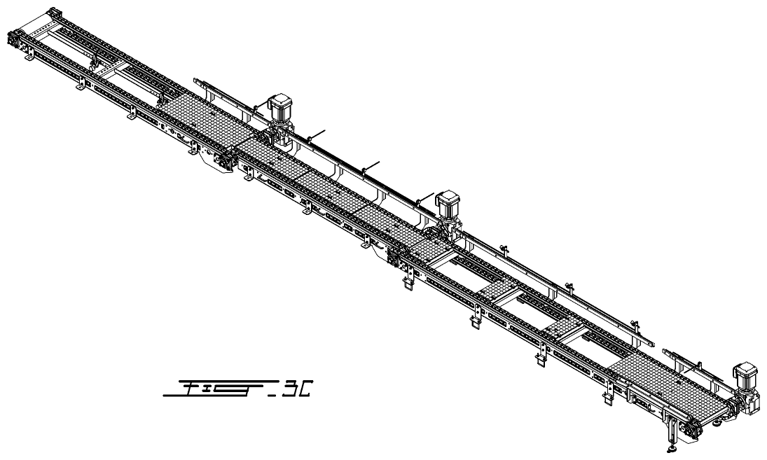

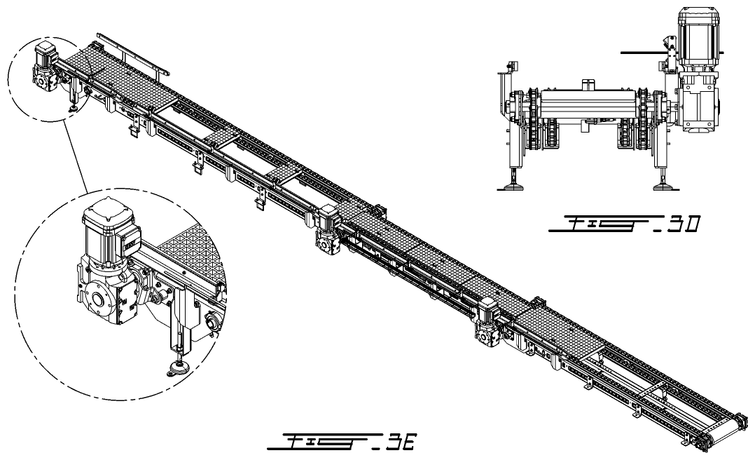

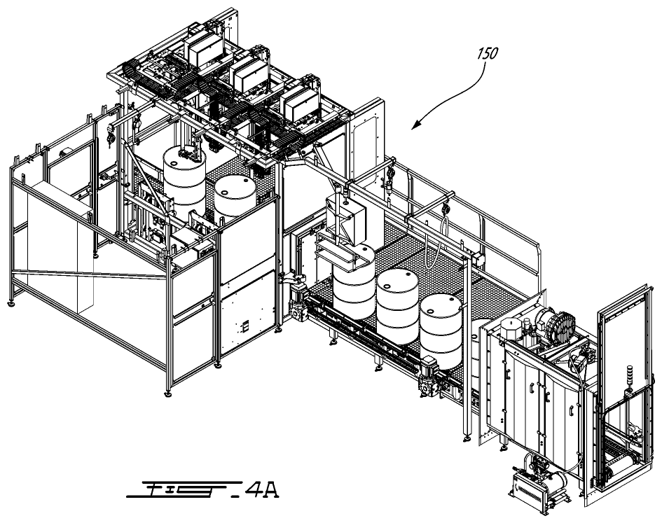

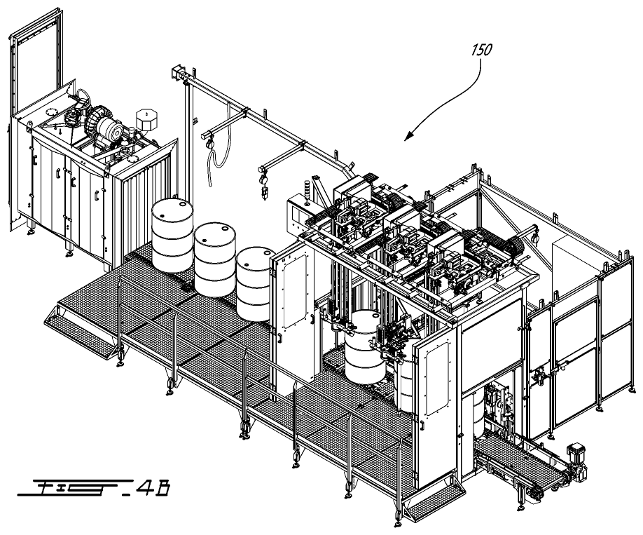

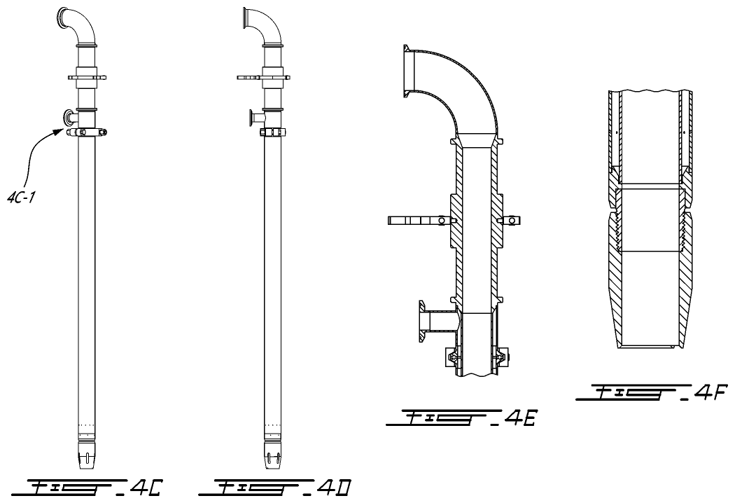

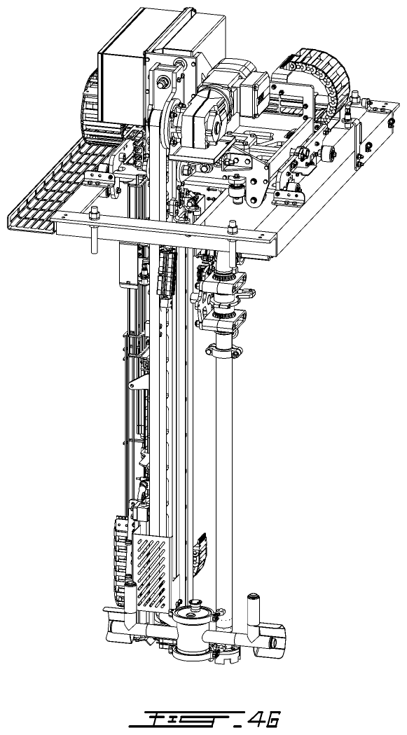

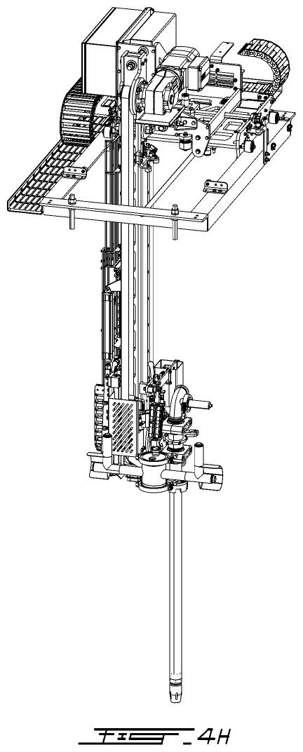

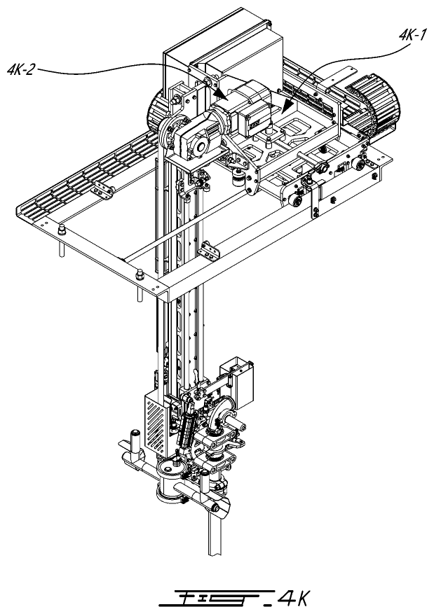

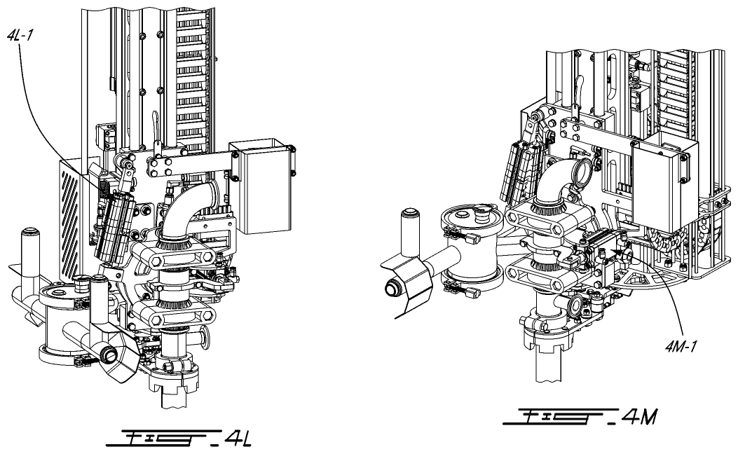

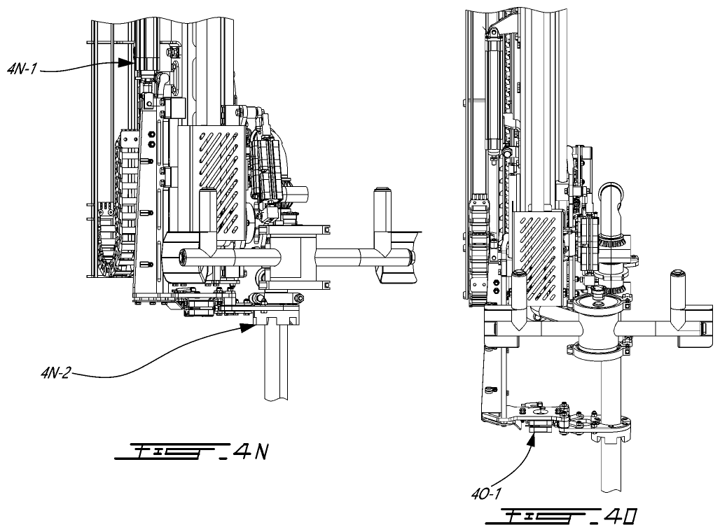

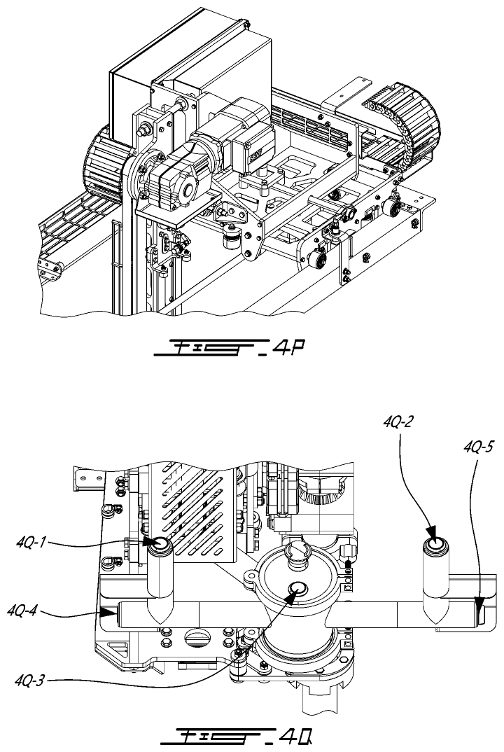

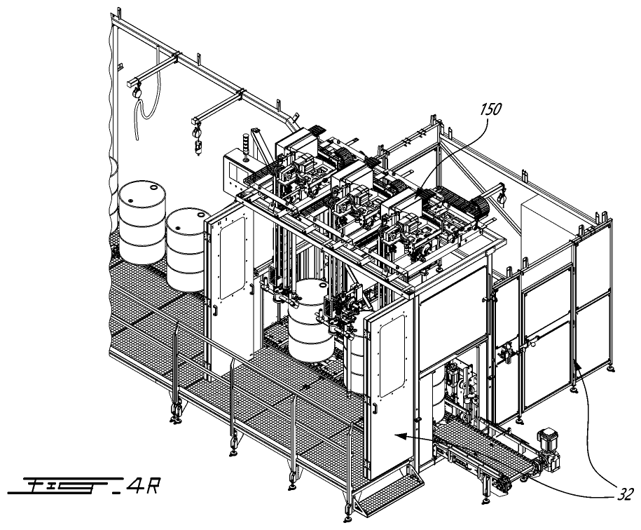

In a system according to an embodiment of an aspect of the present disclosure as schematically shown for example in FIGS. 1 and 2, input containers, such as maple syrup barrels 10 for example, are fed at a delivery landing to a deposit conveyer 20 (FIG. 2B), by an operator O for example, delivered to a gravity conveyer 30 (FIG. 2C) leading to a rinsing tunnel 50 (FIGS. 2D, 2E) for rinsing exterior surfaces of the barrels, in particular the top and the side thereof under hot and high pressurized water jets 14. An air knife 16 removes the exceeding water from the top of the barrels 10 before the barrels 10 are conveyed from the rinsing tunnel 50 by a rinsing tunnel conveyer 40 (FIGS. 2F) to a cap removal station 60 (FIG. 2F). At the cap removal station 60, the caps 12 of the barrels 10 are removed by an operator O, see FIG. 2F for example, and placed into a cap washer to be washed during the washing cycle (see FIG. 2K 140 for example), and the barrels are conveyed to a pumping and washing station 150 (FIGS. 2O, 4A, 4B) by the rinsing tunnel conveyer 40 (FIGS. 2G, 4A). At the pumping and washing station 150, the barrels are lifted by positioning platform lifts 18 (FIG. 2H, FIG. 2O, FIG. 4A); an operator O aligns them into position with the barrel 10 opening positioned at 6 o'clock; the operator O then uses a centering device 4N-2) to secure the position of a wand (FIGS. 4C-4F) over the barrel 10 opening (FIG. 4N) (estimated time: about 45 seconds), closes a safety enclosure 32 (FIGS. 2P, 4R) and activates a pumping and rinsing cycle (estimated time: about 4 minutes). At the end of the pumping and rinsing cycle, the operator O opens the safety enclosure 32 and inspects the barrels 10, then activates a roller chain conveyer (FIG. 2G) transferring the barrels 10 from the pumping and washing station 150 to an exit gravity conveyer 300 ending in a fixed bumper (FIG. 2I) where the barrels 10 are removed at the end of the process.

The deposit conveyer 20 (FIG. 2B) is a motorized roller conveyer, which may be selected with a capacity to support up to three barrels, for example.

The gravity conveyer 30 (FIG. 2C) up to the rinsing tunnel 50 is shown as a gravity feed conveyer, selected to support up to ten barrels, for example, the gravity conveyer 30 may include freely rotating rollers and brake rollers that automatically slow down the movement of the barrels.

The rinsing tunnel conveyer 40 is shown in FIGS. 2D, 2E as a motorized roller chain transfer conveyer selected to deliver up to two barrels through the rinsing tunnel 50. The rinsing tunnel 50 as illustrated includes a rinsing station to rinse the exterior of the barrels 10 under a rotating arch generating high pressure water jets 14, and a drying station where an air knife 16 dries the top of the barrels 10.

At the cap removal station 60 shown in FIG. 2F, the operator O removes the caps 12 of the barrels 10 as discussed hereinabove. FIG. 2F also shows a double transfer conveyer, each one leading to a pumping and washing station, for increasing the washing capacity for example (see also FIG. 1A).

The pumping station conveyer 70 from the barrel cap removal station 60 to the pumping station 150 is shown as a motorized chain conveyer that can support up to four barrels. At the pumping station 150, the barrels 10 are emptied of their maple syrup content, and the retrieved maple syrup being sent, through tubing shown in FIG. 2N for example, to maple syrup receivers, such as tanks 120 (see FIG. 2L for example) using a vacuum system as shown in FIG. 2N for example. Then the barrels 10 are cleaned with steam and hot water, and a resulting sweet water is sent to sweet water receiving tanks 130 (see FIG. 2M for example), using a vacuum unit as shown in FIG. 2N for example. To do this, the wand (FIGS. 4C-4F) is inserted in the opening of the barrels 10 for pumping in the straight position when the barrels 10 are positioned on rollers in positioning and tilting stations (FIG. 2H) so that they can be oriented, using free rotating rollers (4 rollers 2H-1 shown). Then the barrels 10 are lifted by the positioning platform lifts 18 (FIG. 2H, FIG. 2O, FIG. 4A), using two actuators (2H-2 shown) and ultra high molecular weight (UHMW) rollers (2H-3) positioned into a vertical rail (2H-8) for example. Then during the automated sequence, the barrels 10 are tilted, by a pneumatic actuator (2H-4), an adjusting rod (2H-5) and a pivot (2H-6) as illustrated for example, so that last drops of syrup and water product are siphoned off from the barrels 10 while in an inclined position after first emptying in the straight position. During these steps, the weight of the barrels 10 is continuously measured, using load cells (2H-7) for example; and monitored so that after a predetermined length of time without weight variation, the barrels 10 are considered fully emptied and processed to the next step, using the gravity exit conveyer, which may be selected to support up to 12 barrels 10 shown in FIG. 2I for example.

As illustrated in FIG. 2O, the pumping and washing station 150 comprises rigid pipes and valves and a vacuum pump selected to generate up to 22″ HG.

Catwalks may be provided in the system, as shown for example in FIG. 2J, allowing operators to move around.

FIG. 2K shows a cap washer comprising 9 hot water jets 14, for washing the caps 12 during the washing cycle as discussed hereinabove.

FIG. 2L shows a tank receiving the maple syrup pumped from the inside of the barrel, of a capacity of 1180 liters for example, made of 3/16 “thick 316-L stainless steel and; a dished head is configured to withstand up to 22″ HG vacuum for example. Similar tanks, such as illustrated in FIG. 2M may be used for receiving the sweet water after washing of the barrels.

FIG. 2N shows a vacuum system for pumping both syrup and sweet rinsing water. The maple syrup is brought to maple syrup receiving tanks (FIG. 2L; 2N-1). The rinsing water is brought to a water receiving tank (FIG. 2M; 2N-2). Both receiving tanks will be sent to customers.

The safety enclosure 32 of the pumping and washing station is configured to provide protection as hot water and steam are used for cleaning of the inside of the barrels, and during movements of the wand (FIGS. 4C-4F) and lifting stations (FIGS. 2P, 4R). Hot water, steam and descent of the lifting stations may be controlled and activated in connection with the position of the doors of the enclosure, i.e. activated selectively when the doors are closed, using magnetic sensors for example (FIGS. 2Q, 4R). Movement of the wand (FIGS. 4C-4F) may be allowed when the doors are closed or when a hand control is maintained (FIG. 2R). Pumping of the barrels may be selectively started by acting on hand controls even if the doors are open.

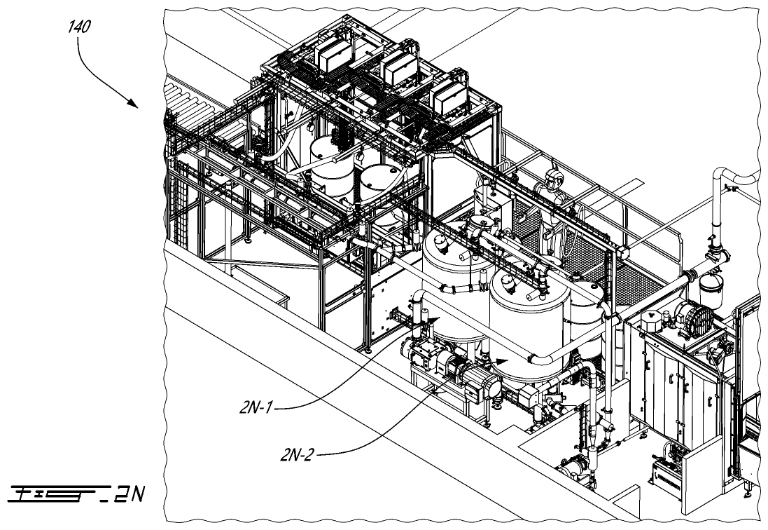

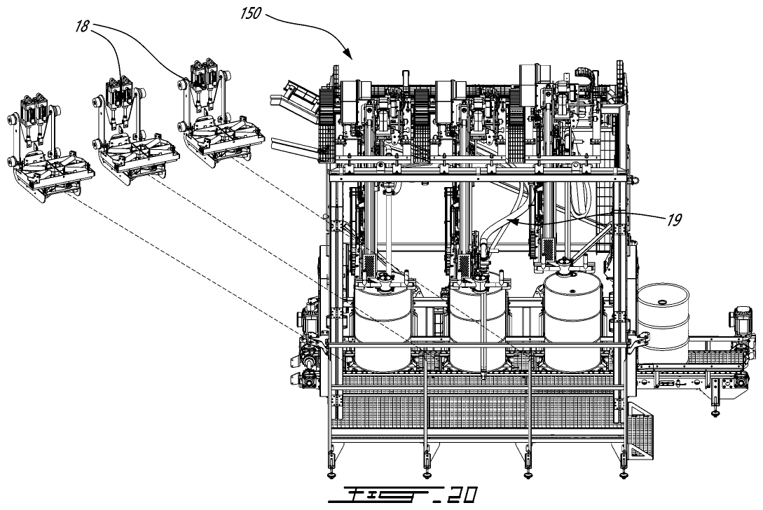

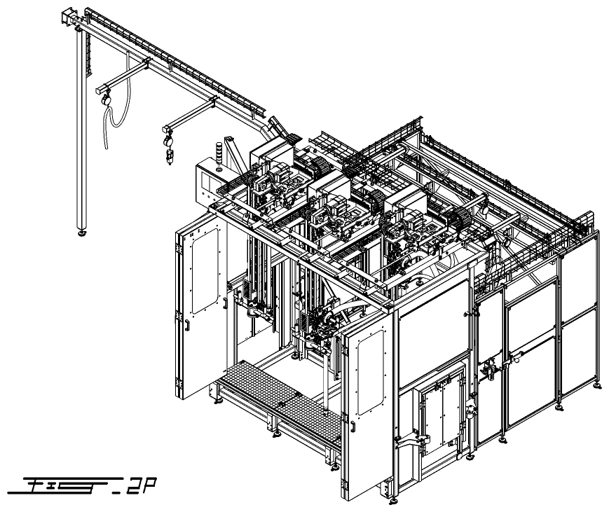

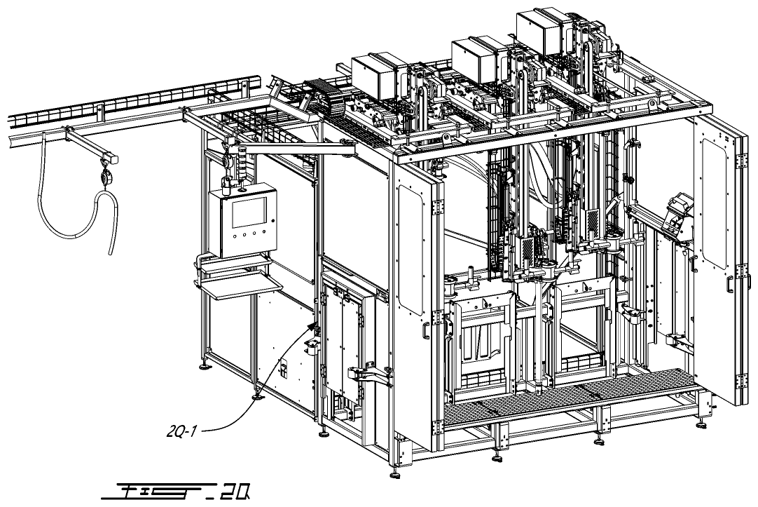

FIGS. 3A-3E show details of conveyers in a system according to an embodiment of an aspect of the present disclosure.

FIGS. 4A, 4B shows a pumping system 200 according to an embodiment of an aspect of the present disclosure.

A same wand (FIGS. 4C-4F) may be used both to siphon the syrup from the barrels 10 by vacuum and to wash the barrels 10 with hot water and steam; multiple jets of 1 mm for example may be used for an efficient washing while minimizing water consumption (FIGS. 4C-4F). The movements in the X and Y axes of the wand (FIGS. 4C-4F) (FIGS. 4G-4J) are controlled by a movement trolley. The movements of the trolley are selectively authorized according to an automated sequence or according to controls on handles of the wand. Pneumatic brakes are positioned on the X and Y axes (4K-1). The wand (FIGS. 4C-4F) is motorized to perform upward and downward movements (4K-2) and a number of pneumatic cylinders allow tilt (4L-1) and rotation (4M-1) movements. A centering tool (4N-2) controlled by a pneumatic cylinder for upward and downward movements is used to align the wand (FIGS. 4C-4F) in the opening of the barrel 10 (FIG. 4N-1); the centering tool comprises jaws actuated by a pneumatic cylinder (4O-1) configured to close around the barrel 10 opening and open in order to allow the inclination of the wand; the movement of the jaws is controlled using a reset command and the upward and downward movement of the centering tool is controlled using handles of the wand. In case of barrels 10 having an opening in the centre when the operator O positions the wand (FIGS. 4C-4F) above the barrels 10, the position of the trolley at this position is detected by a sensor as shown in FIG. 4P, and tilting of these barrels 10 and the wand (FIGS. 4C-4F) are not activated for pumping.

An illuminated capacitive button on a right vertical handle of the wand (FIGS. 4C-4F) (4Q-1) is shown for activation of X and Y movement of the trolley. An illuminated capacitive button on a left vertical handle of the wand (FIGS. 4C-4F) (4Q-2) is shown for activation of downward movement of the centering device. An illuminated capacitive button on each handle of the wand (FIGS. 4C-4F) (4Q-3) is shown for raising the centering device. Two two-handed safety buttons at ends of horizontal handles of the wand (FIGS. 4C-4F) (4Q-4-4Q-5) are shown, for controlling the movement of the wand (FIGS. 4C-4F) and initiating the pumping of the syrup.

The wand (FIGS. 4C-4F) comprises an internal pipe and an external pipe separated by a space configured to build up a pressure of hot water and steam (FIG. 4F). This space comprises two series of nine 1 mm openings selectively positioned and oriented so as to direct hot water and steam to the inner walls of the barrel 10 when the wand (FIGS. 4C-4F) is in rinsing positioning within. The internal pipe is used during the siphoning of the syrup and rinsing water. The wand (FIGS. 4C-4F) may be made in 316-L stainless steel with a dismountable nozzle selected in a plastic material (UHMW) so as not to damage the interior of the drums. The wand (FIGS. 4C-4F) is readily dismounted by dismounting a collard (4C-1) for sliding out the external pipe.

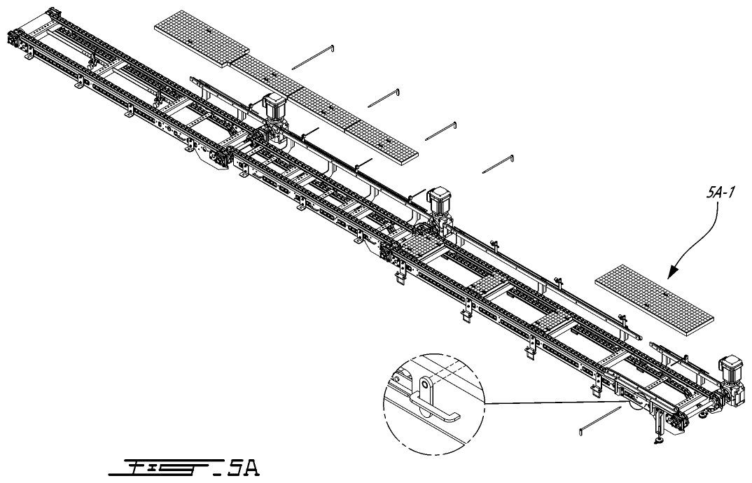

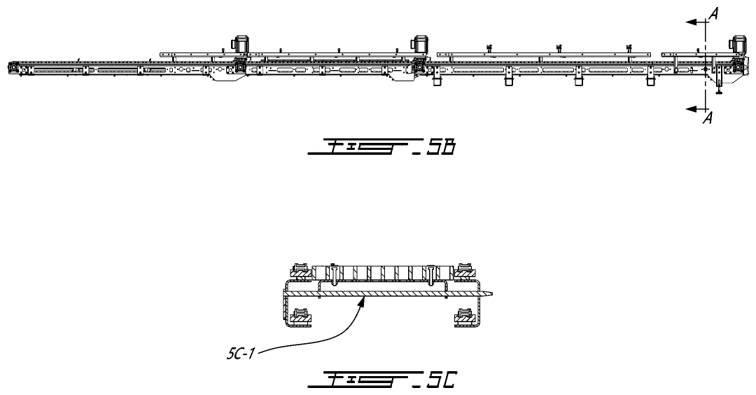

FIG. 5A shows an exploded view of rinsing, transfer and pumping conveyers in a system according to an embodiment of an aspect of the present disclosure. FIG. 5B shows a side view of the rinsing, transfer and pumping conveyers. FIG. 5C shows retaining pins for quick disassembly of a grating (5A-1) used to walk on by operator O for example.

The present method and system for processing containers and high viscosity material contained therein such as oils, sweet water mixtures, molasses or creams, for example.

The scope of the claims should not be limited by the embodiments set forth in the examples but should be given the broadest interpretation consistent with the description.

1. A method for processing containers and viscous material contained therein, comprising:
delivering the containers to a rinsing tunnel;
transferring the containers exiting the rinsing tunnel to a cap removal station;
transferring the containers with respective cap thereof removed, from the cap removal station to a pumping and washing station;
transferring the containers from the pumping and washing station to an exit;
whereby, in a continuous process, exterior surfaces of the containers are rinsed under pressurized water jets in the rinsing tunnel; the cap of each container is removed is the cap removal station to free a top opening therein; at the pumping and washing station, material is pumped from inside of the containers through the opening, pumped material being transferred to first tanks, and the inside of the containers is rinsed;
produced rinsing waters being sent to second tank.

2. The method of claim 1, wherein said pumping of the material from the inside of the containers and transferring the pumped material to the first tanks comprises inserting a wand in the top opening of the containers and pumping from the containers positioned in positioning and tilting stations that orient the containers so that last drops of the material are siphoned off from the containers while in an inclined position after first emptying in a straight position, while continuously monitoring a decreasing weight of the containers, the containers being transferred from the pumping and washing station to the exit when the weight of the containers stabilizes.

3. The method of claim 1, wherein said pumping of the material from the inside of the containers and transferring the pumped material to the first tanks comprises aligning a wand over the top opening and activating a vacuum while continuously monitoring a decreasing weight of the containers, the containers being transferred from the pumping and washing station to the exit when the weight of the containers stabilizes.

4. The method of claim 1, wherein said pumping of the material from the inside of the containers and transferring the pumped material to the first tanks comprises orienting the containers using rollers, lifting the containers using platform lifts, and tilting the containers so that last drops of syrup and water product are siphoned off from the containers while in an inclined position after first emptying in a straight position, while continuously monitoring a decreasing weight of the containers, the containers being transferred from the pumping and washing station to the exit when the weight of the containers stabilizes.

5. The method of claim 1, comprising using a wand to siphon the material from the containers under vacuum and to rinse the inside of the containers with hot water and steam; movements in X and Y axes of the wand being controlled by a trolley; movements of the trolley being selectively driven according to one of : an automated sequence and manual controls on handles of the wand, the wand being driven to perform upward, downward and rotation movements.

6. The method of claim 1, wherein said pumping of the material from the inside of the containers and transferring the pumped material to the first tanks comprises inserting a wand in the top opening of the containers and pumping from the containers positioned in positioning and tilting stations that orient the containers so that last drops of the material are siphoned off from the containers while in an inclined position after first emptying in a straight position, while continuously monitoring a decreasing weight of the containers, the containers being transferred from the pumping and washing station to the exit when the weight of the containers stabilizes; movements in X and Y axes of the wand being controlled by a trolley; movements of the trolley being selectively driven according to one of : an automated sequence and manual controls on handles of the wand; the wand being driven to perform upward, downward and rotation movements.

7. The method of claim 1, wherein said pumping of the material from the inside of the containers and transferring the pumped material to the first tanks comprises aligning a wand over the top opening and activating a vacuum while continuously monitoring a decreasing weight of the containers, the containers being transferred from the pumping and washing station to the exit when the weight of the containers stabilizes; movements in X and Y axes of the wand being controlled by a trolley; movements of the trolley being selectively driven according to one of: an automated sequence and manual controls on handles of the wand; the wand being driven to perform upward, downward and rotation movements.

8. The method of claim 1, wherein said pumping of the material from the inside of the containers and transferring the pumped material to the first tanks comprises orienting the containers using rollers, lifting the containers using platform lifts, and tilting the containers so that last drops of material and water are siphoned off from the containers while in an inclined position after first emptying in a straight position, while continuously monitoring a decreasing weight of the containers, the containers being transferred from the pumping and washing station to the exit when the weight of the containers stabilizes; movements in X and Y axes of the wand being controlled by a trolley; movements of the trolley being selectively driven according to one of : an automated sequence and manual controls on handles of the wand; the wand being driven to perform upward, downward and rotation movements.

9. The method of claim 1, comprising using a wand to siphon the material from the containers under vacuum and to rinse the inside of the containers with hot water and steam, the wand comprising an internal pipe and an external pipe separated by a space comprising openings selectively positioned and oriented to build up a pressure of hot water and steam and to direct the hot water and steam to inner walls of the containers, the internal pipe being used during the siphoning of the material and rinsing water.

10. The method of claim 1, comprising using a wand to siphon the material from the containers under vacuum and to rinse the inside of the containers with hot water and steam, a centering tool aligning the wand in the top opening of the containers; the centering tool comprising jaws actuated by a pneumatic cylinder configured to close around the top opening and open in order to allow inclination of the wand; the movement of the jaws being controlled using a reset command and movement of the centering tool being controlled using handles of the wand.

11. The method of claim 1, wherein the viscous material is one of oils, sweet water mixtures, molasses and creams.

12. A system for processing containers and viscous material contained therein, comprising:
a rinsing tunnel;
a cap removal station;
a pumping and washing station;
receiving tanks; and
conveyers;
wherein, in a continuous process, a deposit conveyer receives input containers at a landing station and delivers the containers to the gravity conveyer leading to the rinsing tunnel for rinsing exterior surfaces of the barrels; a rinsing tunnel conveyer delivers the containers from the rinsing tunnel to the cap removal station for removal of caps from the containers; a pumping station conveyer conveys the containers from the cap removal station to the pumping and washing station; an exit conveyer delivering emptied containers from the pumping and washing station to a delivery exit;
wherein the pumping and washing station comprises stations positioning the containers and a wand connected to a vacuum unit, the containers being positioned for insertion of the wand within the containers and pumping viscous material therefrom, pumped viscous material being transferred to first receiving tanks, and the wand being used to rinse the containers when emptied inside of the containers is rinsed and rinsing waters are delivered to second receiving tanks.

13. The system of claim 12, wherein movements in X and Y axes of the wand are controlled by a trolley, movements of the trolley being selectively driven according to one of: an automated sequence and manual controls on handles of the wand; the wand being driven to perform upward, downward and rotation movements.

14. The system of claim 12, wherein said stations positioning the containers in the washing and pumping comprise positioning and tilting stations that orient the containers so that last drops of the material are siphoned off from the containers while in an inclined position after first emptying in a straight position, while continuously monitoring a decreasing weight of the containers, the containers being transferred from the pumping and washing station when a weight of the containers stabilizes; movements in X and Y axes of the wand being controlled by a trolley;
movements of the trolley being selectively driven according to one of : an automated sequence and manual controls on handles of the wand; the wand being driven to perform upward, downward and rotation movements.

15. The system of claim 12, wherein said exit conveyer deliver emptied containers from the pumping and washing station when a weight of the containers stabilizes; movements in X and Y axes of the wand being controlled by a trolley, movements of the trolley being selectively driven according to one of: an automated sequence and manual controls on handles of the wand, the wand being driven to perform upward, downward and rotation movements.

16. The system of claim 12, wherein said stations positioning the containers in the washing and pumping comprise rollers orienting the containers platforms lifting and tilting the containers so that last drops are siphoned off from the containers while in an inclined position after first emptying in a straight position, while continuously monitoring a decreasing weight of the containers, the exit conveyer transferring the containers from the pumping and washing station to a delivery exit when the weight of the containers stabilizes; movements in X and Y axes of the wand being controlled by a trolley, movements of the trolley being selectively driven according to one of : an automated sequence and manual controls on handles of the wand; the wand being driven to perform upward, downward and rotation movements.

17. The system of claim 12, the wand comprising an internal pipe and an external pipe separated by a space comprising openings selectively positioned and oriented to build up a pressure of hot water and steam and to direct the hot water and steam to inner walls of the containers, the internal pipe being used during the siphoning of the material and rinsing water.

18. The system of claim 12, comprising a centering tool aligning the wand in a top opening of the containers; the centering tool comprising jaws actuated by a pneumatic cylinder configured to close around the top opening and open in order to allow inclination of the wand; the movement of the jaws being controlled using a reset command and movement of the centering tool being controlled using handles of the wand.

19. The system of claim 12, wherein the viscous material is one of oils, sweet water mixtures, molasses and creams.
